(19) United States
(12) Patent Application Publication
(10) Pub. No.: US 2008/0187423 A1
(43) Pub. Date: Aug. 7, 2008

(54) DEVICE FOR EMPTYING POWDER BAGS FOR POWDER SPRAYING APPARATUS

(76) Inventors: Felix Mauchle, Abtwil (CH); Mark Steinemann, Hofstetten (CH); Hanspeter Vieli, Goldach (CH)

Correspondence Address: BARNES & THORNBURG LLP, 11 SOUTH MERIDIAN, INDIANAPOLIS, IN, 46204, US

(21) Appl. No.: 12/023,296

(22) Filed: Jan. 31, 2008

(30) Foreign Application Priority Data
Feb. 2, 2007 (DE) 10 2007 005 307.1

(51) Int. Cl. B65G 65/34

(52) U.S. Cl. 414/415

(57) ABSTRACT

An emptying unit for powder bags used in powder spray coating facilities comprises a bag-receiving hopper which seats a powder bag and is narrower at its bottom than at its top to keep the powder bag dimensionally stable and in a position such that the bag aperture is situated in the upper bag end.

The present invention relates to an emptying device—hereafter emptying unit—for powder bags used in powder spraycoating apparatus—hereafter powder spraycoating facility—as defined in the preamble of claim 1.

### STATE OF THE ART

Powder manufacturers supply spraycoating powders in powder containers which frequently are bags to spraycoating enterprises. The coating powder is sprayed in a spraycoating facility onto the objects to be coated. Then the coating powder is thermally molten on the coated objects. Powder bags may be of conventional shapes. They also may be in the form of a plastic tube or hose fused at the bottom and top and cut open when being used/emptied.

Frequently the powder bags remain in a dimensionally stable cardboard box in the spraycoating facility, in the particular vendor powder bag, while coating powder is removed from it.

### INVENTION

The objective of the present invention is to allow efficiently and effectively emptying soft, flexible powder bags even in the absence of dimensionally stable cardboard boxes.

This problem is solved by the features of claim 1 of the present invention.

Further features of the present invention are defined in the dependent claims and the description below.

The present invention is elucidated below by the description of preferred and illustrative embodiment modes in relation to the appended drawings.

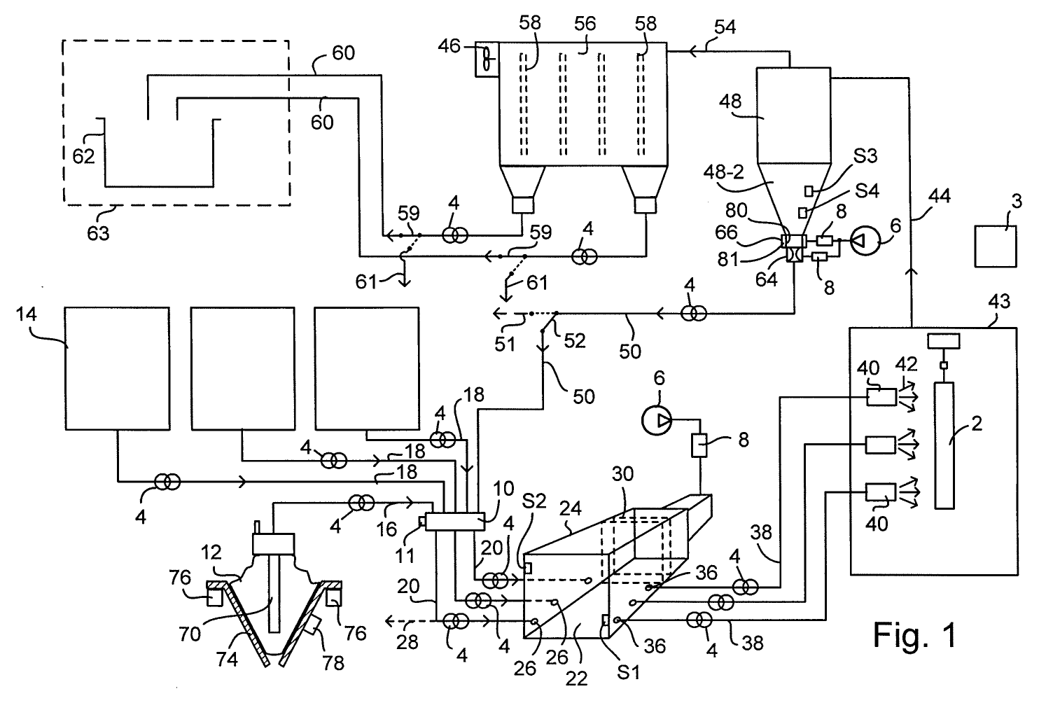

FIG. 1 schematically shows a powder spraycoating facility of the invention as an illustration of one of several different powder spraycoating facilities to which the emptying unit of the invention is advantageously applicable,

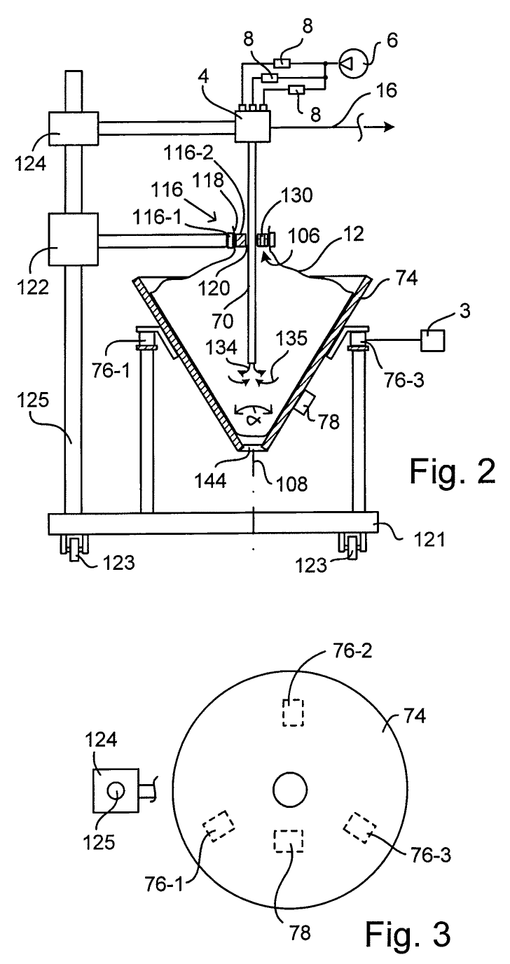

FIG. 2 is a schematic vertical section of an emptying unit of the invention,

FIG. 3 is a topview of a bag-receiving hopper of FIG. 2,

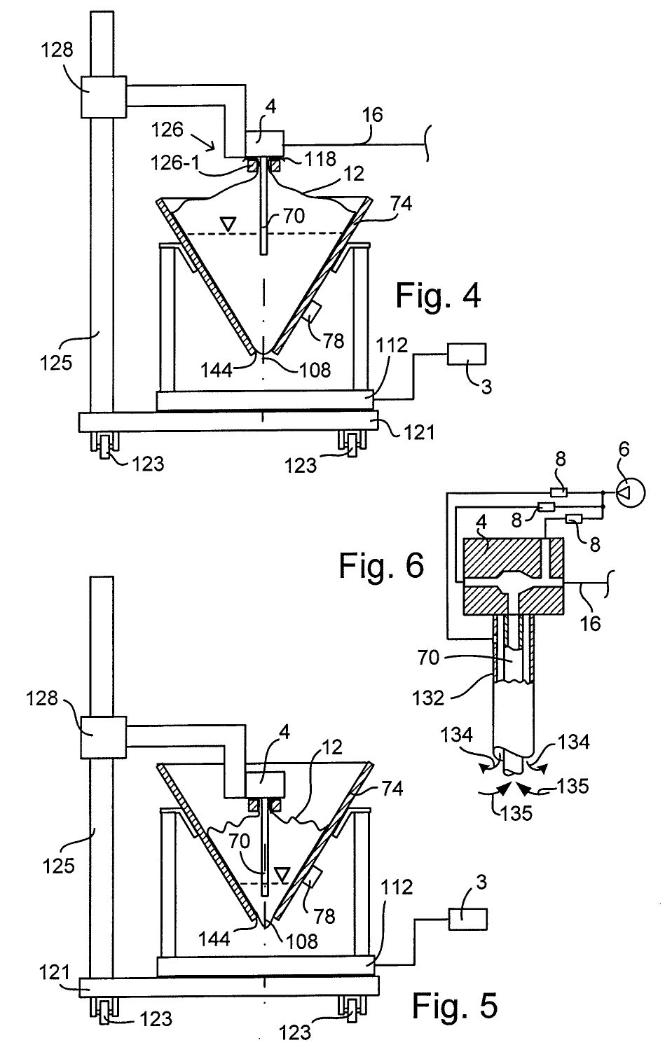

FIG. 4 is a vertical section of another embodiment mode of an emptying unit of the invention holding a full powder bag,

FIG. 5 is a vertical section of the emptying unit of FIG. 4, the powder bag being almost empty,

FIG. 6 schematically shows a cutaway partly in vertical section of a powder feed pipe fitted with an injector as the powder pump at the upper pipe end,

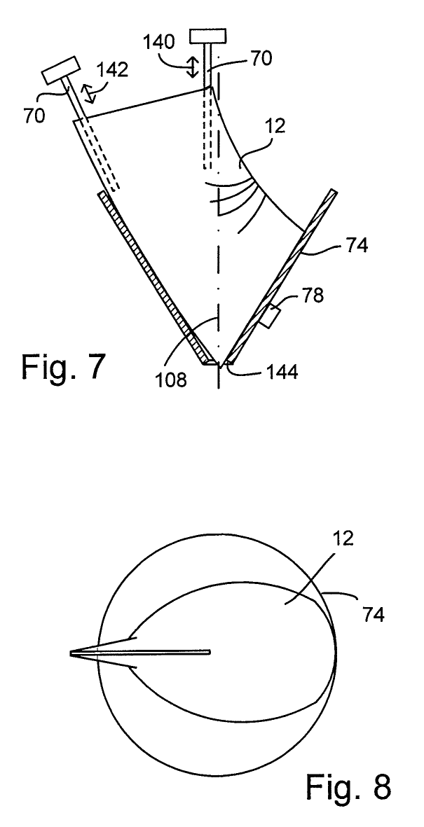

FIG. 7 is a vertical section of the bag-receiving hopper of FIG. 1 and shows various possible positions of a powder bag and a powder feed pipe,

FIG. 8 is a topview of the bag-receiving hopper of FIG. 7 holding a powder bag as yet unopened, and

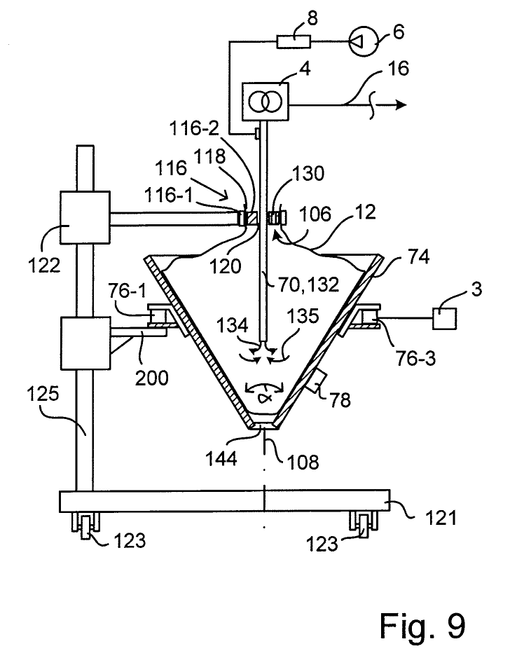

FIG. 9 is a schematic vertical section of still another embodiment mode of the invention.

FIG. 1 schematically shows a preferred embodiment mode of a powder spraycoating facility of the invention to spraycoat objects 2 with a coating powder which subsequently is molten on the object in an omitted oven. One or more electronic controls 3 drive the operations of the powder spraycoating facility. Powder pumps 4 are used to pneumatically feed the coating powder. Said pumps may be injectors into which coating powder is aspirated by compressed air acting as the conveying medium, whereupon the mixture of conveying air and coating powder flows jointly into a receptacle or toward a sprayer.

Illustratively such injectors are known from the European patent document EP 0 412 289 B1.

The powder pumps also may be the kind which consecutively move small powder doses by means of compressed air, each small powder dose (quantity of powder) being stored in a powder chamber and then being expelled by compressed air from the powder chamber. The compressed air remains behind the powder dose and pushes it ahead. This kind of pump is sometimes called a compressed air thrust pump or plug moving pump because the compressed propels the stored powder dose like a plug or stopper through a pump outlet conduit. Various kinds of such powder pumps moving compact coating powder illustratively are known from the following documents: DE 103 53 968 A1; U.S. Pat. No. 6,508,610 B2; US 2006/0193704 A1; DE 101 45 448 A1 and WO 2005/051549 A1.

The invention is not restricted to one of the known kinds of pumps.

A source of compressed air 6 is used to generate the compressed air to pneumatically move the coating powder and fluidize it, said source being connected to the various components by corresponding pressure adjusting elements 8 such as pressure regulators and/or valves.

Fresh powder from the manufacturer is fed from a manufacturer's container—which may be a small container 12, for instance a dimensionally stable container or a bag holding for instance 10 to 50 kg powder, for instance 25 kg, or for instance a large container 14 also dimensionally stable or a bag, holding for instance between 100 kg and 1,000 kg powder—by means of a powder pump 4 in a fresh powder conduit 16 or 18 to a sieve 10. The sieve 10 may be fitted with a vibrator 11. Herein the expressions “small container” and “large container” denote both dimensionally stable containers and those which are not, such as flexible bags, unless specified otherwise.

The coating powder sifted through the sieve 10 is moved by gravity or preferably always by a powder pump 4 through one or more powder feed conduits 20 through powder intake apertures 26 into an intermediate receptacle chamber 22 of a dimensionally stable intermediate receptacle 24. Preferably the volume subtended by the intermediate receptacle 22 is substantially smaller than that of the fresh powder small container 12.

In a preferred embodiment mode of the invention, the powder pump 4 of the minimum of one powder feed conduit 20 leading to the intermediate receptacle 24 is a compressed air pump. In this instance the initial segment of the powder feed conduit 20 may serve as a pump chamber which receives the powder sifted through the sieve 10 as it drops through a valve, for instance a pinch valve. Once this pump chamber contains a given powder dose, the powder feed conduit 20 is shut off from the sieve 10 due to valve closure. Next the powder dose is forced by compressed air through the powder feed conduit 20 into the intermediate receptacle chamber 22.

Preferably the powder intake apertures 26 are configured in a sidewall of the intermediate receptacle 24, preferably near the bottom of the intermediate receptacle chamber 22, so that, when compressed-air flushes the intermediate receptacle chamber 22, even powder residues at the bottom can be expelled through the powder intake apertures 26, and for that purpose the powder feed conduits 20 preferably are separated from the sieve 10 and directed into a waste bin as indicated by a dashed arrow 28 in FIG. 1. The intermediate receptacle chamber 22 is cleaned for instance by a plunger 30 that is fitted with compressed air nozzles and is displaceable through the intermediate receptacle chamber 22.

Powder pumps 4, for instance injectors, are connected to one or more powder outlet apertures 36 to move coating powder through powder conduits 38 to the sprayers 40. The sprayers 40 may be fitted with spray nozzles or rotary atomizers to spray coating powder 42 onto the object 2 to be coated, said object being situated in a coating cabin 43. Preferably the powder outlet apertures 36 are situated in a wall that is opposite the wall containing the powder intake apertures 26. Preferably the powder outlet apertures 36 also are configured near the bottom of the intermediate receptacle chamber 22

Preferably the size of the intermediate receptacle chamber 22 allows storing coating powder in amounts between 1.0 and 12 kg, preferably between 2.0 and 8.0 kg. In other words, the size of the intermediate receptacle chamber 22 preferably shall be between 500 and 30,000 cm³, preferably between 2,000 and 20,000 cm³. The size of the intermediate receptacle chamber 22 is selected as a function of the number of powder outlet apertures 36 and of powder conduits 38 connected to them in a manner to permit continuous spraycoating while also permitting rapidly cleaning the intermediate receptacle chamber 22 in pauses of operation for purposes of powder changes, preferably in automated manner. The intermediate receptacle chamber 22 may be fitted with a fluidizing means to fluidize the coating powder.

Coating powder 42 failing to adhere to the object 2 is aspirated as excess powder through an excess powder conduit 44 by means of a flow of suction air from a blower 46 into a cyclone separator 48. In the cyclone separator, the excess powder is separated as much as possible from the suction flow. The separated powder proportion is then moved as recovered powder from the cyclone separator 48 through a recovery powder conduit 50 to the sieve 10 and from there it passes through said sieve either by itself or being admixed to fresh powder through the powder feed conduits 20 and once more into the intermediate receptacle chamber 22.

Depending on the kind of powder and/or the intensity of powder soiling, the powder recovery conduit 50 also may be separated from the sieve 10 and move the recovery powder into a waste bin as schematically indicated by a dashed line 51 in FIG. 1. In order that the powder recovery conduit need not be separated from the sieve 10, it may be fitted with a switch allowing connecting it either to the sieve 10 or to a waste bin.

The intermediate receptacle 24 may be fitted with one or more sensors, for instance two sensors S1 and/or S2 to control feeding coating powder into the intermediate receptacle chamber 22 by means of the control 3 and the powder pumps 4 in the powder feed conduits 20. Illustratively the lower sensor S1 detects a lower powder level limit and the upper sensor S2 detects an upper powder level limit.

The lower end segment 48-2 of the cyclone separator 48 can be designed and used as a recovery powder supply silo and be used as such and be fitted for that purpose with one or several illustratively two sensors S3 and/or S4 which are operationally connected to the control 3. As a result the fresh powder feed through the fresh powder feed conduits 16 and 18 may be stopped, especially in automated manner, until enough recovery powder shall accumulate in the cyclone separator 48 to feed through the sieve 10 enough recovery powder into the intermediate receptacle chamber 22 for spraycoating using the sprayer 40. Once the recovery powder becomes insufficient in the cyclone separator 48 for such operation, the switchover to the fresh powder supply through the fresh powder conduits 16 or 18 may automatically kick in. The invention also offers the possibility to simultaneously feed fresh and recovery powders to the sieve 10 to admix them to one another.

The exhaust air of the cyclone separator 48 passes through an exhaust air conduit 54 into a post filtration system 56 and therein through one or more filter elements 58 to arrive at the blower 46 and beyond latter into the atmosphere. The filter elements 58 may be filter bags or filter cartridges or filter plates or similar elements. Ordinarily the powder separated from the air flow by means of the filter elements 58 is waste powder and drops by gravity into a waste bin, or, as shown in FIG. 1 it may be moved by means of one or several waste conduits 60 each fitted with a powder pump 4 into a waste bin 62 at a waste station 63.

Depending on the kind of powder and on the powder coating conditions, the waste powder also may be recovered and moved to the sieve 10 in order to be recirculated into the coating circuit. This feature is schematically indicated in FIG. 1 by switches 59 and branch conduits 61 of the waste conduits 60.

Typically only cyclone separators 48 and the post filtration system 56 are used for multicolor operation, wherein different colors each are sprayed only for a short time, and the waste powder of the post filtration system 56 is moved into the waste bin 62. In general the powder-separating efficiency of the cyclone separator 48 is less than that of the post filtration system 56, but cleaning is more rapid than in the post filtration system 56. As regards monochrome operation, wherein the same powder is used for a long time, the cyclone separator 48 may be dispensed with, and the excess powder conduit 44 instead of the exhaust air conduit 54 may be connected to the post filtration system 56, and the waste conduits 60—which in this instance contain recovery powder—are connected as powder recovery conduits to the sieve 10. Typically the cyclone separator 48 is used in combination with the post filtration system 56 in monochrome operation only when the coating powder entails problems. In such eventuality only the recovery powder of the cyclone separator 48 is moved through the powder recovery conduit 50 to the sieve 10 whereas the waste powder of the post filtration system 56 is moved into the waste bin 62 or into another waste bin, said waste bin being optionally free of waste conduits 60 and directly positioned underneath an outlet aperture of the post filtration system 56.

The lower end of the cyclone equipment 48 may be fitted with an outlet valve 64, for instance a pinch valve. Moreover fluidizing means 66 to fluidize the coating powder may be configured above said outlet valve 64, in or at the lower end segment 48-2, constituted as a supply container of the cyclone separator 48. The fluidizing means 66 contains at least one fluidizing wall 80 made of material comprising open pores or fitted with narrow boreholes, this material being permeable to compressed air but not to the coating powder. The fluidizing wall 80 is situated between the powder path and a fluidizing compressed air chamber 81. The fluidizing compressed air chamber 81 may be connected by a compressed air adjusting element 8 to the compressed air source 6.

For the purpose of evacuating fresh coating powder by suction, the fresh powder conduit 16 and/or 18 may be connected to allow powder flow at is upstream end either directly or through the powder pump 4 to a powder feed pipe 70, said pipe being dippable into the vendor's container 12 or 14. The powder pump 4 may be mounted at the beginning of, the end of or in-between in the fresh powder conduit 16 or 18 or at the upper or lower end of the powder moving pipe 70.

A small fresh powder container in the form of a fresh powder bag 12 is shown in FIG. 1 held in a bag-receiving hopper 74. The bag-receiving hopper 74 keeps the powder bag 12 in a specified shape, the bag aperture being at the upper bag end. The bag-receiving hopper 74 may be mounted on a scale or on weighing sensors 76. These scale or weighing sensors depending on their design may generate visual displays and/or electrical signals that, following subtraction of the weight of the bag-receiving hopper 74, will correspond to the weight and hence the quantity of the coating powder in the small container 12. Preferably a minimum of one vibrator 78 is mounted at the bag-receiving hopper 74 to shake it.

Two or more small containers 12 may be configured each in one bag-receiving hopper 74, also two or more large containers 14 operating alternately. This feature allows rapidly changing from one small container 12 to another or one large container 14.

The invention may be modified in a number of ways without restricting it. For instance the sieve 10 may be integrated into the intermediate receptacle 24. Alternatively the sieve 10 may be omitted when the fresh powder quality is high enough. In that case a separate sieve may be used to sift the recovery powder of the conduits 44 and 50, illustratively upstream or downstream of the cyclone separator 48 or in it. Again, sifting the recovery powder will not be required when its quality is adequate for re-use.

The preferred embodiment mode of the invention provides an emptying unit fitted with a bag-receiving hopper 74. Preferred embodiment modes of the emptying unit are illustrated in the FIGS. 2 through 9 below. The bag-receiving hopper 74 is narrower at the bottom to hold the powder bag 12 whereby the hopper wall imparts dimensional stability to said bag and keeps it in a position wherein the bag aperture 106 is situated at the upper bag end.

The hopper conical angle a at the inside of the bag-receiving hopper 74, also preferably at its outside surface, preferably is between 45 and 90°, in particular between 50 and 70°, illustratively about 60°. The powder bag 12 may be in the form of a plastic sheet/pouch, in particular a large plastic tube which at its lower end is fused together and there constitutes the lower bag end. This pouch also may be fused shut at its upper end. In that case the lower bag end must be cut open to remove coating powder. Preferably the hopper angle is selected in a manner that as the quantity of powder in the powder bag decreases, the powder particles are able to slide by gravity down the bag wall.

The hopper center axis 108 of the bag-receiving hopper 74 preferably shall be vertical. In other embodiment modes however the hopper center axis 108 also may be selected being oblique as long the hopper-like inside surface of this hopper runs everywhere obliquely upwards.

As shown in the Figures, the cross-section of the bag-receiving hopper 74 orthogonal to the hopper center axis 108 preferably is circular everywhere regardless of height, though it is understood other cross-sections also may be used, for instance having an oval or polygonal contour.

In a special embodiment mode of the invention, the bag-receiving hopper 74 is fitted with at least one weight sensor measuring the weight of the bag-receiving hopper 74 including its contents, in particular the quantity of powder. The minimum of one weight sensor may be designed to optically display the weight and/or that the signal generator, for instance the control 3, which is operationally connected to said sensor, shall generate a signal based on the measured weight. In a particular embodiment mode of the invention, this signal shall be generated whenever a given minimum weight has been reached or was fallen short of. Moreover signals may also be generated as a function of two or more different weights of powder, for instance one signal indicating the minimum weight will materialize imminently and/or that the powder bag shall soon be empty.

In FIGS. 2 and 3, the weighing system is in the form of three weighing cells 76 (76-1, 76-2 and 76-3 bearing the load of the bag-receiving hopper 74 at three different peripheral sites. FIGS. 4 and 5 show a scale 112 as the weighing/seating system for the bag-receiving hopper 74.

The signal generated by the weighing system 76 or 112 of by the control 3 operationally connected to said system and based on the measured weight illustratively may be acoustic or optical, letting an operator know that the powder bag 12 is nearly empty and needs replacing. The weighing system 76 or 112 per se or the control 3 connected to it may furthermore be designed in a manner that in addition to or in lieu of said acoustic and/or optic signals, they shall also generate control signals driving the powder feed as a function of the measured powder weight when measuring predetermined weight values. One signal may be an early warning to an operator that the powder bag 12 soon shall be empty and must be replaced. Also such a signal may be used to stop the fresh powder feed from the powder bag 12 and instead feeding its recovery powder from the lower end segment 48-2 of the cyclone separator 48—designed as a supply container—to the sieve 10, provided that a sensor S3 or S4 situated there, if there are two sensors for instance the upper sensor S3, does transmit the information to the control 3 that enough recovery powder is present in the supply container 48-2 of the cyclone separator 48, and provided that the sensor S1 of the intermediate receptacle 24 does transmit a “powder needed” signal to the control 3.

The bag-receiving hopper 74 may be fitted with one or several vibrators 78 to shake the bag-receiving hopper 74 in order to shake coating powder off the bag wall and to boost the replenishment of coating powder sliding into the powder bag as the powder quantity in latter is decreasing.

FIGS. 2 and 3 show a bag aperture edge retaining means 116 comprising an outer retaining element 116-1 to grip the upper bag end zone 118 near its aperture edge and an inner retaining element 116-2 for insertion into the upper bag end zone 118 near its aperture edge. The two retaining elements 116-1 and 116-2 preferably may be tightened/stretched toward each other so they may clamp the upper bag end zone 118 between them.

The inner retaining element 116-2 may be fitted with a top to bottom feedthrough aperture 120 passing the powder feed pipe 70. The aperture edge retaining means 116 preferably is designed as a guide guiding the powder feed pipe 70 moving in the pipe's longitudinal direction.

The aperture edge retaining means 116 may be stationary. Preferably however it is mechanically linked to a height-adjusting device 122 that preferably shall be automatically controlled to move said retaining means up and down.

Preferably the powder feed pipe 70 is vertically displaceable, preferably in freely moving manner whereby it can dip by gravity into the powder bag 12 and will track the downward moving powder level. However the powder pipe 70 also may be mechanically linked to a height adjusting device 124 to be moved up and down by said device.

The two height adjusting devices 124 and 122 are mounted at a preferably vertical guide bar 125 and preferably are vertically adjustable along it.

The bag-receiving hopper 74, the weighing system 76 or 112 and the guide system 125, 122, 124 preferably are configured on a base plate 121. This base plate may be fitted with wheels/casters 123 to move it.

The embodiment mode of FIGS. 4 and 5 includes a bag aperture edge retention means 126 comprising an outer retaining element 126-1 to seize the upper bag end segment 118 near its aperture edge and an inner retention element for insertion into the upper bag end segment near its aperture edge, the inner retaining element being constituted by the powder feed pipe 70 and the outer retaining element 126-1 being radially tensible/stretchable against the powder feed pipe 70 or an intermediate element. The powder feed pipe 70 runs from top to bottom, preferably vertically.

The bag aperture retaining means 126 of FIGS. 4 and 5 may be mounted in stationary manner to a support such as a bar 125. Preferably however said retaining means is mechanically linked to an automatically controlled raising/lowering device 128 driving it up and down for instance along a guide bar 125.

In every embodiment mode of the invention, the powder feed pipe 70 points down by its lower end as far as the lower hopper end or is displaceable into the vicinity of said hopper end to allow aspirating coating powder even from the very bottom of the powder bag.

In the preferred embodiment modes shown in the drawings, the powder pipe 70 is configured along the hopper center axis and displaceable up and down along that axis.

Preferably the upper bag end shall be closed by means of the bag-aperture retaining means 116 of FIGS. 2 and 3 respectively 126 of FIGS. 4 and 5 to preclude coating powder particles from escaping out of the powder bag into the atmosphere. Where pressure compensation is needed in the powder bag, a pressure compensating opening 130 may be fitted into said bag to aerate and/or vent it. Illustratively the pressure compensating opening 130 may be constituted within the bag aperture edge retaining means, for instance in the inner element 116-2 of FIG. 2. However such a pressure compensating opening also may be subtended in an element connected to the powder feed pipe 70 or at another site of the powder bag or a powder pump.

In a further embodiment mode of the invention, the powder pump 4 of the fresh powder feed conduit 16 is configured at the upper end of the powder feed pipe 70. This powder pump may be any known pump.

The powder feed pipe 70 may be a single or a plurality of powder pipes.

FIG. 6 shows a preferred embodiment mode comprising two radially spaced pipes connected to each other to form one double pipe unit. This double pipe contains at its inside the powder feed pipe 70 and radially outward a fluidizing air pipe 132 to supply fluidizing compressed air from a compressed air source 6 through a pressure regulator 8 to the lower pipe end where the fluidizing air 134 (FIG. 2) exits and there fluidizes the coating powder 135; in other words: said powder is made to float in the fluidizing compressed air to allow the powder pump 4 to more easily move it pneumatically through the powder feed pipe 70.

The powder pump 4 moving fresh powder out of the powder bag 12 may be configured in the fresh powder conduit 16 or, in the preferred embodiment mode, at the upper end of the powder feed pipe 70 as illustratively shown by means of an injector in FIG. 6. Conveying compressed air is applied from the compressed air source 6 through a pressure regulator 8 to the injector 4 and generates a partial vacuum in the injector 4 to aspirate coating powder 135 out of the powder bag 12 and through the powder feed pipe 70. The coating powder aspirated by the conveying compressed air mixes with latter and jointly they flow as a mixture of powder and compressed air through the fresh powder supply conduit 16. Additional compressed air from the compressed air source 6 may be applied through a further compressed air regulator 8 situated at the end of the injector or at the beginning of the fresh powder supply conduit 16.

FIGS. 2 through 5 show the feasibility to vertically emplace a powder bag 12 into the bag-receiving hopper 74. FIGS. 7 and 8 show the possibility to put a powder bag in place obliquely on the inside surface of the bag-receiving hopper 74. FIG. 7 furthermore shows the two possibilities to place in this instance two powder feed pipes 70 running obliquely in and along the hopper center axis 108 or parallel to the hopper inside surface and in the downward direction and being displaceable as shown by the double arrows 140 respectively 142 toward the lower hopper end or away from it.

The bag-receiving hopper 74 may be closed at its lower end. Preferably however it is fitted at its lower end with a downward pointing hopper opening 144. Coating powder that accidentally leaves the powder bag and moves into the bag-receiving hopper 74 is able to drop out of this lower hopper opening 144. This lower hopper opening furthermore offers the feasibility of opening the powder bag in the bag-receiving hopper 74 at its lowest bag site, for instance to pierce it open or to cut off a downward bag snippet in order to remove coating powder, in particular residual powder, in the down direction.

Regardless of a hopper opening 144 being present or not, the bottom diameter of the bag-receiving hopper 74 is substantially smaller than that of the powder bag 12. The diameter of the upper hopper end is at least as large as that of the powder bag 12. The inside cross-sectional diameter/diagonal of the bag-receiving hopper 74 perpendicularly to the hopper center axis 108 is substantially less at the lower hopper end than at the upper one, being preferably 50% or less, preferably 25% especially preferably 10% or less than the cross-sectional dimension at the upper end.

The bag-receiving hopper 74 preferably shall be conical and circular over its full height. Other shapes than circular, for instance oval or polygonal ones, also are possible. The bag-receiving hopper 74 may comprise a non-conical segment at its lower and/or upper ends.

The appropriate respective frequencies of the vibrator 78 driving the bag-receiving hopper 74 and of the vibrator 11 driving the sieve 10 may be determined empirically. Illustratively mechanical vibrators run as fast as 120 Hz. Pneumatic vibrators for instance run at frequencies as high as 18 kHz. Ultrasonic vibrators run at frequencies as high as 34 kHz.

FIG. 9 shows a preferred embodiment of the invention. In this design, the bag-receiving hopper 74 is supported by a pivoting beam 200 pivotable about a vertical axis and mounted on the guide bar 125. Jointly with the bag-receiving hopper 74, the pivot beam 200 is independently pivotable and thereby can pivot relative to the aperture edge retaining means 116. In this manner the bag-receiving hopper 74 can be pivoted laterally away, underneath the aperture edge retaining means 116 and out of the zone of the powder feed pipe 70 when this pipe does not dip into the bag-receiving hopper 74, and it can be loaded with a powder bag at a site laterally offset from the powder feed pipe 70. Moreover the pivotable beam 200 may be designed to be adjustable in height. In another, omitted embodiment of the invention, the bag-receiving hopper 74 is not supported by a pivot beam 200, instead it is mounted on an omitted slide or carriage and jointly with same can be displaced laterally out of the zones of the powder feed pipe 70 and of the opening edge retaining means 116 to load the bag-receiving hopper 74 with a powder bag 12, respectively to remove said bag from it.

Components already found in previously discussed embodiment modes and shown again in FIG. 9 are denoted by the same references.

The powder pump 4 of the fresh powder conduit 16 is an injector or preferably a compressed-air thrust pump (plug moving pump) and is configured at the upper end of the powder feed pipe 70. Jointly the powder pump 4 of the fresh powder conduit 16, also preferably jointly with a fluidizing air pipe 132, the powder feed pipe 70 is mounted to be freely vertically displaceable, so that this sub-assembly is able by gravity to automatically track the powder level in the powder bag.

A weighing scale or at least one of the weighing cells 76-1, 76-2 and 76-3 may be configured between the bag-receiving hopper 74 and the pivot beam 200 or between the pivot beam 200 and the guide bar 125 or underneath the guide bar 125.

An optical weight display or another weight signal from the scale 112 or the weighing cells 76-1, 76-2 and 76-3 can be nulled in all embodiment modes of the invention when the bag-receiving hopper 74 is devoid of any powder bag 12 and be tared in this manner. Therefore when a powder bag 12 rests in the bag-receiving hopper 74, the weight display/signal from the scale/weighing cells only indicates the weight of the powder bag 12, not the additional weight of the bag-receiving hopper 74.

1. A powder-bag emptying unit for powder spray coating facilities, comprising a bag-receiving hopper which is designed to receive a powder bag, said bag-receiving hopper being narrower at its bottom than at its top, the hopper wall keeping the powder bag dimensionally stable and in a fixed position wherein a bag aperture is situated at the top end of the bag, the bag-receiving hopper being fitted at its lower end at the hopper center with a hopper opening which is open downward and permits coating powder to drop out of it, the bag-receiving hopper further being fitted with at least one vibrator to shake said bag-receiving hopper.

2. A powder-bag emptying unit as claimed in claim 1 the wherein a hopper angle of the hopper inside surface is between 45 and 90°.

3. A powder-bag emptying unit as claimed in claim 1 wherein the hopper further comprises a center axis that extends vertically.

4. A powder-bag emptying unit as claimed in claim 1 wherein the bag-receiving hopper is oriented on at least one weight sensor for measuring the weight of the bag-receiving hopper including the hopper contents.

5. A powder-bag emptying unit as claimed in claim 1 wherein the of at least one weight sensor is connected to a signal generator for generating a signal based on the measured weight.

6. A powder-bag emptying unit as claimed in claim 1 further comprising an aperture-edge retaining means comprising an outer retaining element to grip the upper bag segment near an aperture edge of the bag aperture and an inner retaining element for insertion into the upper bag segment near its aperture edge, the two retaining elements being stretchable relative to each other to clamp the upper bag segment between them, the upper inner retaining element comprising a downward pointing passage to pass a powder feed pipe.

7. A powder-bag emptying unit as claimed in claim 6 wherein the aperture edge retaining means is mechanically connected to a height adjusting device and can be moved up and down by said device.

8. A powder-bag emptying unit as claimed in claim 6 wherein the powder feed pipe is connected to a height adjusting device and can be moved up and down by said height adjusting device.

9. A powder-bag emptying unit as claimed in claim 1 further including an aperture edge retaining means comprising an outer retaining element to grip the upper bag end segment near the aperture edge of the bag aperture and an inner retaining element for insertion into the upper bag end segment near its aperture edge, the two retaining elements being mutually stretchable to insert the upper bag end segment between them, the inner retaining element comprising at least one of a powder feed pipe or and a pipe containing a powder feed pipe, said pipe being inserted downward through the bag aperture into the powder bag situated in the bag-receiving hopper.

10. A powder-bag emptying unit as claimed in claim 9 wherein the aperture edge retaining means is connected mechanically to a height adjusting device and said retaining means can be moved up and down by said height adjusting device.

11. A powder-bag emptying unit as claimed in claim 1 wherein a lower end of the powder feed pipe points toward the lower hopper end and is displaceable downward as far into the vicinity of the lower hopper end.

12. A powder-bag emptying unit as claimed in claim 6 wherein the powder feed pipe is oriented along the hopper center axis and points in a longitudinal direction of said axis, and can be displaced along the longitudinal direction of said axis.

13. A powder-bag emptying unit as claimed in claim 6 wherein the powder feed pipe is oriented parallel to the inside surface of the receiving-bag hopper and is displaceable up and down parallel to the hopper inside surface.

14. A powder-bag emptying unit as claimed in claim 1 wherein an inside cross-sectional dimension of the bag-receiving hopper orthogonal to the hopper center axis is at least 50% smaller at the lower hopper end than at the upper hopper end.

15. A powder-bag emptying unit as claimed in claim 1 further including a powder pump mounted at the upper end of the powder feed pipe.

16. A powder-bag emptying unit as claimed in claim 1 wherein the bag-receiving hopper is mounted in a manner to be laterally displaceable into different positions.

17. A powder-bag emptying unit as claimed in claim 1 wherein the hopper further comprises a center axis that extends vertically.

18. A powder-bag emptying unit as claimed in claim 2 wherein the bag-receiving hopper is oriented on at least one weight sensor for measuring the weight of the bag-receiving hopper including the hopper contents.

19. A powder-bag emptying unit as claimed in claim 3 wherein the bag-receiving hopper is oriented on at least one weight sensor for measuring the weight of the bag-receiving hopper including the hopper contents.

20. A powder-bag emptying unit as claimed in claim 17 wherein the bag-receiving hopper is oriented on at least one weight sensor for measuring the weight of the bag-receiving hopper including the hopper contents.
